(19) United States
(12) Patent Application Publication
(10) Pub. No.: US 2024/0199997 A1
(43) Pub. Date: Jun. 20, 2024

(54) COMPOSITIONS COMPRISING A META-(C1-C4 ALKOXY) SALICYLALDEHYDE

(71) Applicant: The Procter & Gamble Company, Cincinnati, OH (US)

(72) Inventors: Bernardo M. AGUILERA-MERCADO, Kenwood, OH (US); Mu WANG, Cincinnati, OH (US); Philip John PORTER, Mason, OH (US); Ryan Johnie SMITH, Cincinnati, OH (US); Gregory Scot MIRACLE, Liberty Township, OH (US); Karen Hussong STRADER, Springboro, OH (US); Fabrizio MELI, Montgomery, OH (US)

(21) Appl. No.: 18/533,367

(22) Filed: Dec. 8, 2023

Related U.S. Application Data
(60) Provisional application No. 63/431,054, filed on Dec. 8, 2022.

(51) Int. Cl. C11D 3/50; C11B 9/00; C11D 3/20

(52) U.S. Cl. CPC C11D 3/50; C11B 9/0061; C11D 3/2072

(57) ABSTRACT

Compositions, such as consumer products and/or fragrance/flavoring compositions, that include a meta-(C1-C4 alkoxy)salicylaldehyde, such as ortho-ethylvanillin. Processes of making and using such compositions.

### FIELD OF THE INVENTION

The present disclosure relates to compositions, such as consumer products and/or fragrance/flavoring compositions, that include a meta-(C1-C4 alkoxy)salicylaldehyde, such as ortho-ethylvanillin. The present disclosure further relates to processes of making and using such compositions.

### BACKGROUND OF THE INVENTION

Consumer products, such as cleaning products and fine fragrances, that have vanilla-scented fragrances are very popular. Such scents can be provided by compounds in the vanillin family, such as vanillin and ethylvanillin. Because ethylvanillin is perceived as having a greater intensity than vanillin, ethylvanillin may even be preferred to save raw material costs, carbon footprint and/or formulation space.

However, these materials can present challenges to the manufacturer and/or the consumer. For example, due to relatively high melting points, high boiling points, and/or low vapor pressures, the materials are associated with various processing, formulation, and/or performance issues, such as the tendency to crystallize at ambient temperatures. Furthermore, the materials may be characterized by relatively low solubility in certain commercially useful solvents such as isopropyl myristate, making them inconvenient to process or formulate into products or intermediate compositions.

There is a need for improved vanilla-scented consumer products, compositions, and related processes that address these issues.

### SUMMARY OF THE INVENTION

The present disclosure relates to compositions, such as consumer products and/or fragrance/flavoring compositions, that include a meta-(C1-C4 alkoxy)salicylaldehyde compound, such as ortho-ethylvanillin.

For example, the present disclosure relates to a consumer product that includes: a first fragrance material that is a meta-(C1-C4 alkoxy)salicylaldehyde, where the first fragrance material is present in an amount of at least 0.0005%, by weight of the consumer product composition, and a treatment adjunct.

The present disclosure also relates to a consumer product that includes: a first fragrance material that is a meta-(C1-C4 alkoxy)salicylaldehyde, an optional second fragrance material selected from the group consisting of vanillin, ethylvanillin, or a combination thereof, where the weight ratio of the first fragrance material to the second fragrance material, if present, is from 100:0 to 1:99; and a treatment adjunct.

The present disclosure also relates to a fragrance or flavoring composition that includes: a first fragrance material that is a meta-(C1-C4 alkoxy)salicylaldehyde, preferably meta-(C1-C2 alkoxy)salicylaldehyde, more preferably meta-(C2 alkoxy)salicylaldehyde, where the first fragrance material is present in an amount of at least 0.005%, by weight of the fragrance or flavoring composition, and a second fragrance material that is different from the first fragrance material.

The present disclosure also relates to a process of making a consumer product, the process including the steps of: combining a first fragrance material with a treatment adjunct or a substrate, where the first fragrance material is a meta-(C1-C4 alkoxy)salicylaldehyde, preferably meta-(C1-C2 alkoxy)salicylaldehyde, more preferably meta-(C2 alkoxy)salicylaldehyde.

The present disclosure also relates to a process of treating a surface or an environment, the process including the step of providing a meta-(C1-C4 alkoxy)salicylaldehyde, preferably a meta-(C1-C2 alkoxy)salicylaldehyde, more preferably a meta-(C2 alkoxy)salicylaldehyde, to a surface or environment.

The present disclosure also relates to a use of a meta-(C1-C4 alkoxy)salicylaldehyde, preferably a meta-(C1-C2 alkoxy)salicylaldehyde, more preferably a meta-(C2 alkoxy)salicylaldehyde, to provide a vanilla-type fragrance to a consumer product, a surface, or an environment.

### DETAILED DESCRIPTION OF THE INVENTION

The present disclosure relates to compositions, consumer products, and processes that include meta-(C1-C4 alkoxy)salicylaldehyde. These fragrance materials have isomeric structures and scents that are similar to the more commonly used vanilla-scented materials (e.g., vanillin and/or ethylvanillin).

However, as described in more detail, the materials have certain advantageous characteristics that can make them more attractive to product manufacturers. For example, relatively lower melting temperatures can make them easier to pump through a pipe at lower temperatures, thereby resulting in lower energy costs to the manufacturer. Lower boiling points and/or higher vapor pressures enable them to volatilize more easily and be perceived by a consumer under normal usage conditions. Additionally, they are generally more soluble than their isomeric counterpart in common carriers or solvents, such as isopropyl myristate, making them more convenient to formulate, particularly at relatively higher levels.

The fragrance materials, compositions, consumer products, and related processes are discussed in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, “consumer products” can include baby care, beauty care, fabric & home care, family care, feminine care, health care, food (including snack), beverage, and/or fine fragrance products or devices generally intended to be used or consumed in the form in which it is sold. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals, pet health and nutrition; food products, including processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); beverages, including carbonated beverages, tea, flavored water, and coffee; and water purification.

As used herein the phrase “fabric care product” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (C) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. meta-(C1-C4 alkoxy)salicylaldehyde

The compositions, products, and processes described herein include a meta-(C1-C4 alkoxy)salicylaldehyde compound. As described in more detail below, it is believed that such materials can provide a vanilla-like scent to compositions and products while also having certain advantageous characteristics that facilitate more convenient processing and/or improved performance.

As described herein, the meta-(C1-C4 alkoxy)salicylaldehyde compound is described as a (first) fragrance material. However, it is understood that, at acceptable levels and where appropriate, the compounds may also be used as flavoring materials.

The basic structure of a meta-(C1-C4 alkoxy)salicylaldehyde compound is provided below as Formula I:

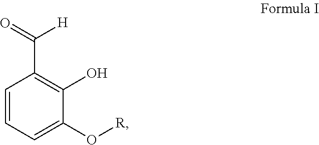

where R is a C1-C4 alkyl group (e.g., having from one to four carbon atoms). In other words, the —O—R group is the “C1-C4 alkoxy” group of the meta-(C1-C4 alkoxy)salicylaldehyde.

The C1-C4 alkoxy group comprises from one to four carbon atoms. Due to structural similarities to vanillin and ethylvanillin, the alkoxy group is preferably a C1-C2 alkoxy group having from one to two carbon atoms (e.g., R is a C1-C2 alkyl group). More preferably, the group is a C2 alkoxy group that has two carbon atoms (e.g., R is a C2 alkyl group). It may also be preferred that the group is a C1 alkoxy group that has one carbon atom (e.g., R is a C1 alkyl group). It may also be preferred that the alkoxy group is a C2-C4 alkoxy group that has from two to four carbon atoms. The meta-(C1-C4 alkoxy)salicylaldehyde materials of the present disclosure may include compounds that have different alkoxy groups (e.g., mixtures of compounds having Cl alkoxy groups with other compounds having C2 alkoxy groups).

The C1-C4 alkyl group may be linear or branched, preferably the C1-C4 alkyl group is linear.

When the meta-(C1-C4 alkoxy)salicylaldehyde is a meta-(C1 alkoxy)salicylaldehyde, it is also known as ortho-vanillin. Ortho-vanillin has the following structure, shown as Formula II:

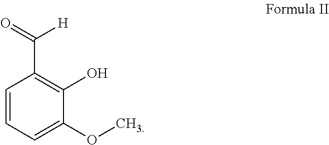 [SMILES: COc1cccc(C=O)c1O]

Other names for ortho-vanillin include: 2-hydroxy-3-methoxybenzaldehyde; 3-methoxysalicylaldehyde; or simply o-vanillin. Ortho-vanillin is identified by CAS No. 148-53-8. Ortho-vanillin, having the hydroxyl group at the ortho-position, is an isomer of vanillin, which has the hydroxyl group at the para-position.

When the meta-(C1-C4 alkoxy)salicylaldehyde is a meta-(C2 alkoxy)salicylaldehyde, it is also known as ortho-ethylvanillin. Ortho-ethylvanillin has the following structure, shown as Formula III:

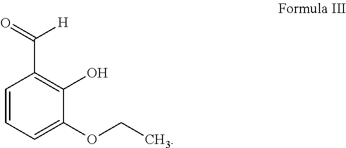 [SMILES: CCOc1cccc(C=O)c1O]

Other names for ortho-ethylvanillin include: novovanillin; 2-hydroxy-3-ethoxybenzaldehyde; 3-ethyoxysalicylaldehyde; or simply o-ethylvanillin. Ortho-ethylvanillin is identified by CAS No. 492-88-6. Ortho-ethylvanillin, having the hydroxyl group at the ortho-position, is an isomer of ethylvanillin, which has the hydroxyl group at the para-position.

As described further in the Examples section below, ortho-vanillin (i.e., meta-(C1 alkoxy)salicylaldehyde) and ortho-ethylvanillin (i.e., meta-(C2 alkoxy)salicylaldehyde) are characterized by certain characteristics, including melting point, boiling point, and LogP, that may make them desirable substitutes for, or co-ingredients with, vanillin and/or ethylvanillin.

Consumer Products

The present disclosure relates to consumer products that comprise a meta-(C1-C4 alkoxy)salicylaldehyde. Typically, the consumer products will also comprise a treatment adjunct. Additionally or alternatively, the consumer product may comprise a meta-(C1-C4 alkoxy)salicylaldehyde that is provided to a substrate.

The consumer product may take any suitable form. Preferably, the consumer product is a baby care product, a beauty care product, a fabric care product, a home care product, a family care product, a feminine care product, a health care product, a food product, a beverage product, a fine fragrance product, or a combination thereof. The consumer products of the present disclosure may be compositions, devices, or combinations thereof that are useful in baby care, beauty care, fabric care, home care, family care, feminine care, health care, food, beverage, and/or fine fragrance applications. For consumer health reasons, it may be preferred that the consumer product is not a tobacco-related product, such as cigarettes, e-cigarettes, or products (such as aerosols) intended to give a tobacco-like aroma.

The consumer product may preferably be a fabric care product and/or a home care product, wherein the home care product is selected from the group consisting of a hard surface cleaner, a dish care product, an air care product, or a combination thereof. The consumer product may be a cleaning and/or treatment product.

The consumer product may take any suitable form or combination of forms. For example, the consumer product may comprise a form selected from a liquid composition, a granular composition, a hydrocolloid, a single-compartment pouch, a multi-compartment pouch, a dissolvable sheet, a pastille or bead, a fibrous article, a tablet, a stick, a bar, a flake, a spray, a foam/mousse, a non-woven sheet, a dispensing device, a cream, an absorbent article, a paste, an adhesive, an adhesive patch, or a mixture thereof. The consumer product may be a composition, such as a liquid composition, that is housed in a container, dispensing device, or other suitable article.

The consumer product may comprise a first fragrance material that is a meta-(C1-C4 alkoxy)salicylaldehyde, where the first fragrance material is present in an amount of at least 0.0005%, by weight of the consumer product, and a treatment adjunct.

Advantageously, the properties of the meta-(C1-C4 alkoxy)salicylaldehydes described herein may allow them to be incorporated into consumer products at relatively higher levels than their isomeric counterparts. For example, because the materials of the present disclosure are relatively more soluble in common solvents or carriers (such as isopropyl myristate) than their isomeric counterparts, relatively greater amounts can be dissolved or otherwise formulated while maintaining adequate stability.

The consumer product may comprise the first fragrance material (e.g., the meta-(C1-C4 alkoxy)salicylaldehyde) in an amount of at least 0.0005%, preferably at least 0.001%, more preferably at least 0.01%, preferably in an amount of at least 0.1%, preferably at least 0.5%, more preferably at least 1%, by weight of the consumer product. It is preferred to have a certain minimum amount of the first fragrance material present in order to deliver the desired olfactory performance.

The consumer product may comprise the first fragrance material (e.g., the meta-(C1-C4 alkoxy)salicylaldehyde) in an amount of up to about 99%, preferably up to an amount of about 50%, preferably up to about 25%, more preferably up to about 10%, even more preferably up to about 5%, even more preferably up to about 1%, by weight of the consumer product. It may be preferred to have a certain maximum amount or limit of the first fragrance material present in order to include other adjuncts or fragrance materials

The consumer product may comprise the first fragrance material (e.g., the meta-(C1-C4 alkoxy)salicylaldehyde) in an amount of from about 0.01% to about 99%, preferably from about 0.1% to about 50%, more preferably from about 0.5% to about 10%, more preferably from about 1% to about 5%, by weight of the consumer product.

The first fragrance materials (e.g., meta-(C1-C4 alkoxy)salicylaldehyde), particularly C1 and/or C2 alkoxy materials (e.g., ortho-vanillin and/or ortho-ethylvanillin), may be known to be in the presence of their isomeric counterparts (e.g., vanillin and/or ethylvanillin) when synthetically produced. However, the meta-(C1-C4 alkoxy)salicylaldehyde materials are typically treated as undesirable impurities that should be removed. In contrast, the present disclosure affirmatively seeks to formulate these materials into products and compositions due to their desirable characteristics. Thus, it may be desirable to formulate products and/or compositions that include certain weight ratios of the presently disclosed materials to their isomeric counterparts, including at weight ratios that are greater than 1:1.

For example, the consumer product may comprise: a first fragrance material that is a meta-(C1-C4 alkoxy)salicylaldehyde; an optional second fragrance material selected from the group of vanillin, ethylvanillin, or a combination thereof; and a treatment adjunct; wherein the weight ratio of the first fragrance material to the second fragrance material, if present, is from 100:0 to 1:99.

The weight ratio of the first fragrance material to the second fragrance material (i.e., vanillin, ethylvanillin, or mixtures thereof) may be from 100:0 to 1:99, preferably from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1.

It may be particularly preferred to control the weight ratio of the meta-(C1-C4 alkoxy)salicylaldehyde to its isomeric counterpart. For example, the weight ratio of ortho-vanillin to vanillin may be from 100:0 to 1:99, preferably from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1. The weight ratio of ortho-ethylvanillin to ethylvanillin may be from 100:0 to 1:99, preferably from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1.

It may be preferred to formulate only the presently disclosed materials and to leave out their isomeric counterparts. For example, the consumer product may be substantially free of a second fragrance material selected from the group of vanillin, ethylvanillin, and a combination thereof. In particular, a consumer product may comprise ortho-vanillin and be substantially free of vanillin. Additionally or alternatively, a consumer product may comprise ortho-ethylvanillin and be substantially free of ethylvanillin.

As described above, the consumer product comprises a first fragrance material that is a meta-(C1-C4 alkoxy)salicylaldehyde. Preferably, the first fragrance material is a meta-(C1-C2 alkoxy)salicylaldehyde (i.e., ortho-vanillin, ortho-ethylvanillin, or a mixture thereof). More preferably, the first fragrance material is a meta-(C2 alkoxy)salicylaldehyde (i.e., ortho-ethylvanillin).

The alkoxy group in the first fragrance material may be a linear or branched alkoxy group, preferably a linear alkoxy group.

For convenient availability, it may be preferred that the first fragrance material is synthetically prepared. For environmental reasons, it may be preferred that the first fragrance material is naturally derived. When vanillin and/or ethylvanillin are present, it may be preferred for the first fragrance material to be naturally derived and present in a relatively large quantity. For example, the first fragrance material may be present in a weight ratio to a second fragrance, where the second fragrance material is selected from the group of vanillin, ethylvanillin, and a combination thereof, where the weight ratio is equal to or greater than 1:1.

The first fragrance material may be present as a free oil in the consumer product, or it may be part of a perfume delivery system. For example, the meta-(C1-C4 alkoxy)salicylaldehyde may be encapsulated, or otherwise associated with (e.g., embedded in), a delivery particle. For example, the meta-(C1-C4 alkoxy)salicylaldehyde may be in the core of a core-shell delivery particle. The meta-(C1-C4 alkoxy)salicylaldehyde may be covalently or ionically bonded, preferably covalently bonded, to a carrier material, thereby forming a pro-fragrance material that releases the meta-(C1-C4 alkoxy)salicylaldehyde when the bond is broken, such as through exposure to water or light. Thus, the first fragrance material, e.g., the meta-(C1-C4 alkoxy)salicylaldehyde, may be part of a perfume delivery system, where the perfume delivery system is a delivery particle, a pro-fragrance material, or a combination thereof.

As described above, the consumer product comprises a treatment adjunct. The treatment adjunct material may provide a benefit in the intended end-use of a composition, or it may be a processing and/or stability aid. The precise nature of the treatment adjunct(s), and levels of incorporation thereof, will depend on the physical form of the composition and the nature of the operation for which it is to be used. One of ordinary skill will be able to select appropriate materials and levels for a given product or application.

Suitable treatment adjuncts may include surfactants, conditioning actives, deposition aids, rheology modifiers or structurants, bleach systems, stabilizers, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, silicones, hueing agents, aesthetic dyes, neat perfume, additional perfume delivery systems, structure elasticizing agents, carriers, hydrotropes, processing aids, anti-agglomeration agents, coatings, formaldehyde scavengers, pigments, or mixtures thereof.

The treatment adjunct may comprise a carrier. Such carriers may be hydrophilic (e.g., water) or hydrophobic (e.g, an oil) in nature. The presently described meta-(C1-C4 alkoxy)salicylaldehyde are relatively hydrophobic in nature, and may be conveniently coupled with a hydrophobic carrier. Particularly useful carriers in consumer products include, but are not limited to, isopropyl myristate (IPM), dipropylene glycol, propylene glycol monomethyl ether (DPM), tripropyleneglycol monomethyl ester (TPM), triethyl citrate (TEC), or mixtures thereof. Thus, the consumer product may comprise a carrier, where the carrier is preferably IPM, DPM. or mixtures thereof. Preferably, the carrier comprises isopropyl myristate.

Isopropyl myristate, as well as other hydrophobic carriers, may be particularly useful when the meta-(C1-C4 alkoxy)salicylaldehyde is encapsulated in certain core-shell delivery particles, such as those having acrylate-based or chitosan-based shells. The cores of the delivery particles may comprise both the isopropyl myristate and the meta-(C1-C4 alkoxy)salicylaldehyde, preferably C1-C2 alkoxy, more preferably C2 alkoxy.

### Fragrance or Flavoring Composition

The present disclosure also relates to fragrance or flavoring compositions. Such compositions typically comprise mixtures of fragrance and/or flavoring ingredients. The fragrance or flavoring compositions of the present disclosure may take the form of premixes or intermediate compositions that are combined with other materials to make final products, such as consumer products.

For example, the fragrance or flavoring composition may take the form of a fragrance composition that is a mixture of fragrance materials, such as a perfume accord that may be formulated into a consumer product.

The fragrance or flavoring composition may comprise a first fragrance material and a second fragrance material that is different than the first fragrance material, where the first fragrance material is a meta-(C1-C4 alkoxy)salicylaldehyde, preferably meta-(C1-C2 alkoxy)salicylaldehyde, more preferably meta-(C2 alkoxy)salicylaldehyde, and where the first fragrance material is present in an amount of at least 1%, by weight of the fragrance or flavoring composition.

The first fragrance material may be present in an amount of at least 0.005%, preferably at least 0.05%, or even 0.1%. The first fragrance material may be present in an amount of from about 0.005% to about 10%, preferably from about 0.05% to about 3%, more preferably from about 0.1% to about 1.5%. The first fragrance material may be present in an amount of at least 1%, preferably at least 2%, more preferably at least 5%, or even at least 10%, or even at least 20%, by weight of the fragrance or flavoring composition. The first fragrance material may be present in an amount of from 1% to about 99%, preferably from 1% to about 50%, more preferably from about 1% to about 25%, more preferably from about 1% to about 10%, even more preferably from about 1% to about 5%, by weight of the fragrance or flavoring composition.

The second fragrance material may be a perfume raw material. The term “perfume raw material” (or “PRM”) as used herein refers to compounds having a molecular weight of at least about 100 g/mol and which are useful in imparting an odor, fragrance, essence or scent, either alone or with other perfume raw materials. Typical PRMs comprise inter alia aromatic and/or aliphatic alcohols, ketones, aldehydes, esters, ethers, carboxylic acids, nitriles, nitrites and alkenes, such as terpene, and alkynes. A listing of common PRMs can be found in various reference sources, for example, “Perfume and Flavor Chemicals”, Vols. I and II; Steffen

Arctander Allured Pub. Co. (1994) and “Perfumes: Art, Science and Technology”, Miller, P. M. and Lamparsky, D., Blackie Academic and Professional (1994).

The second fragrance material may be vanillin, ethylvanillin, or a mixture thereof. That being said, it may be particularly preferred to control the weight ratio of the meta-(C1-C4 alkoxy)salicylaldehyde to its isomeric counterpart. For example, the weight ratio of ortho-vanillin to vanillin may be from 100:0 to 1:99, preferably from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1. The weight ratio of ortho-ethylvanillin to ethylvanillin may be from 100:0 to 1:99, preferably from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1.

The second fragrance material may be selected from the group consisting of any fragrance material that is suitable for the intended product or end use. As non-limiting, illustrative examples, suitable second fragrance materials are provided below in Table A. The second fragrance material may be selected from the group provided in Table A, or combinations thereof.

TABLE A

| PRM | CAS |
|---|---|
| ALPHA DAMASCONE | 24720-09-0 |
| ALPHA PINENE | 80-56-8 |
| ALPHA-TERPINOLENE | 586-62-9 |
| AMBRONAT | 6790-58-5 |
| ANISIC ALDEHYDE | 123-11-5 |
| BENZYL ACETATE | 140-11-4 |
| BETA GAMMA HEXENOL | 928-96-1 |
| BETA PINENE | 127-91-3 |
| CARYOPHYLLENE EXTRA | 87-44-5 |
| CIS 3 HEXENYL ACETATE | 3681-71-8 |
| CITRONELLOL | 106-22-9 |
| COUMARIN | 91-64-5 |
| CYMAL | 103-95-7 |
| DECYL ALDEHYDE | 112-31-2 |
| DELTA DAMASCONE | 57378-68-4 |
| DIHYDRO MYRCENOL | 18479-58-8 |
| DIMETHYL OCTANOL | 106-21-8 |
| ETHYL MALTOL | 4940-11-8 |
| ETHYL-2-METHYL BUTYRATE | 7452-79-1 |
| GAMMA DECALACTONE | 706-14-9 |
| GAMMA TERPINENE COEUR | 99-85-4 |
| GERANIOL | 106-24-1 |
| GERANYL ACETATE | 105-87-3 |
| HABANOLIDE | 111879-80-2 |
| HELIOTROPIN | 120-57-0 |
| HEXYL ACETATE | 142-92-7 |
| HEXYL CINNAMIC ALDEHYDE | 101-86-0 |
| IONONE BETA | 14901-07-6 |
| IONONE GAMMA METHYL | 127-51-5 |
| ISO E SUPER OR WOOD | 68155-67-9 |
| LAEVO TRISANDOL | 28219-61-6 |
| LIGUSTRAL-1 | 68039-49-6 |
| LIMONENE | 5989-27-5 |
| LINALOOL | 78-70-6 |
| LINALYL ACETATE | 51685-40-6 |
| METHYL ANTHRANILATE | 134-20-3 |
| METHYL DIHYDRO JASMONATE | 24851-98-7 |
| METHYL IONONE ALPHA | 127-42-4 |
| METHYL PHENYL CARBINYL ACETATE | 93-92-5 |
| MYRCENE | 123-35-3 |
| N-BETA-METHYL IONONE ISOMER | 79-70-9 |
| NEROL | 106-25-2 |
| NERYL ACETATE | 141-12-8 |
| NONALACTONE | 63357-97-1 |
| OCIMEME | 3779-61-1 |
| PARA CYMENE | 99-87-6 |
| PHENYL ETHYL ALCOHOL | 60-12-8 |
| SABINENE | 3387-41-5 |
| UNDECALACTONE | 104-67-6 |
| VERDOX | 88-41-5 |

In order to provide a full and desirable olfactory experience, the fragrance or flavoring composition may comprise three or more fragrance materials. The fragrance or flavoring composition may further comprise a third fragrance material. The fragrance or flavoring composition may comprise from two to about fifty fragrance materials, preferably from two to about thirty fragrance materials. For simplicity and ease of manufacturing, it may be desirable to limit the number of components of the fragrance or flavoring composition. For example, the fragrance or flavoring composition may comprise from two to about twenty, or to about fifteen, or to about ten, fragrance materials.

The fragrance or flavoring composition may further comprise a carrier, preferably a carrier comprising isopropyl myristate (IPM), dipropylene glycol, propylene glycol monomethyl ether (DPM), tripropyleneglycol monomethyl ester (TPM), triethyl citrate (TEC), or a mixture thereof, more preferably a carrier comprising isopropyl myristate.

Other useful carriers may be solvents or emulsifiers, such as nonionic surfactants, which may help with incorporation of the fragrance or flavoring composition into a final product form. The fragrance or flavoring composition may be in the form of an emulsion, preferably an oil-in-water emulsion.

The fragrance or flavoring composition of the present disclosure may be incorporated into a consumer product, which are described in more detail above. Thus, the present disclosure relates to a consumer product comprising the fragrance or flavoring composition as described herein. Preferably, the consumer product is a baby care product, a beauty care product, a fabric care product, a home care product, a family care product, a feminine care product, a health care product, a food product, a beverage product, a fine fragrance product, or a combination thereof.

The fragrance or flavoring composition may be present in the consumer product in an amount of at least 0.1%, preferably at least 0.5%, more preferably at least 1%, by weight of the consumer product. The fragrance or flavoring composition may be present in the consumer product in an amount of from about 0.1% to about 99.9%, or from about 0.1% to about 50%, or from about 0.1% to about 25%, or from about 0.1% to about 10%, or from about 0.1% to about 5%, or from about 1% to about 5%, by weight of the consumer product.

### Additional Fragrance Materials:

The fragrance compositions disclosed herein may also include additional fragrance materials. Some non-limiting examples of such additional fragrance materials are listed in Table B below. At least one of the additional fragrance materials listed in Table B may be utilized alone in a consumer product, or utilized in a consumer product in combination with any other fragrance materials disclosed herein.

TABLE B

| IUPAC Name | CAS Number |
|---|---|
| 1-[1-(2-ethylbutyl)cyclohexyl]propan-1-one | |
| 1-(3,5-dimethyl-1-adamantyl)ethanone | 40430-57-7 |
| 1-(1-adamantyl)butan-1-one | 24556-00-1 |
| 1-(1-adamantyl)ethanone | 1660-04-4 |
| 1-(1-adamantyl)heptan-1-one | 32665-99-9 |
| 1-(1-adamantyl)hexan-1-one | 32665-97-7 |
| 1-(1-adamantyl)propan-1-one | 1660-05-5 |
| 1-but-2-enyl-4-methylbenzene | 21003-53-2 |
| 1-(lambda1-methoxy)naphthalene | 2216-69-5 |
| 1-pentoxy-4-propoxybenzene | 2650262-16-9 |
| 3-[(2,5-diethylfuran-3-yl)disulfanyl]-2,5-diethylfuran | 2650948-13-1 |
| 3-[(2,5-dimethylfuran-3-yl)disulfanyl]-2,5-dimethylfuran | 28588-73-0 |
| 2-ethyl-3-[(2-ethyl-5-methylfuran-3-yl)disulfanyl]-5- | |
| methylfuran | |
| 2-methyl-3-[(2-methylfuran-3-yl)disulfanyl]furan | 28588-75-2 |
| 1,4-dipentoxybenzene | 32527-64-3 |
| 1,4-diethynylbenzene | 30700-96-0, |
| | 26713-43-9, |
| | 935-14-8 |
| 1-ethyl-4-prop-2-enylbenzene | 18640-62-5 |
| 1-methyl-4-prop-2-enylbenzene | 3333-13-9 |
| 1-butoxy-4-pentoxybenzene | 2650948-13-1 |
| 1-ethoxy-4-pentoxybenzene | 2225737-76-6 |
| 1-ethynyl-4-methylbenzene | 766-97-2, |
| | 34807-69-7 |
| 1-methoxyanthracene | 61128-86-7 |
| 1-methoxynaphthalene | 2216-69-5 |
| 2-butylcyclohexan-1-one | 1126-18-7 |
| 2-ethylcyclohexan-1-one | 4423-94-3 |
| 2-methylbenzo[g][1,3]benzoxazole | 20686-65-1 |
| 2-nonylcyclohexan-1-one | 16556-72-2 |
| 2-pentylcyclohexan-1-one | 280575-02-2, |
| | 32362-97-3 |
| 2-propylcyclohexan-1-one | 64870-42-4, |
| | 94-65-5 |
| 3-(p-tolyl)prop-1-en-1-one | |
| 3,5,5-trimethylcyclohex-2-en-1-ol | 114818-71-2, |
| | 470-99-5 |
| 3,5-diethylbenzaldehyde | 81698-95-5 |
| 3-butyl-5,5-dimethylcyclohex-2-en-1-ol | 133969-86-5 |
| 3-(disulfanyl)-2,5-dimethylfuran | |
| 3-ethoxy-3-oxo-2-phenylpropanoic acid | 17097-90-4 |
| 3-ethyl-5,5-dimethylcyclohex-2-en-1-ol | 31952-19-9 |
| 3-ethyl-5-methylbenzaldehyde | 3132-93-2 |
| 3-ethylbenzaldehyde | 34246-54-3 |
| 5,5-dimethyl-3-(2-methylpropyl)cyclohex-2-en-1-ol | 1478030-64-6 |
| 3-propan-2-ylbenzaldehyde | 34246-57-6 |
| 4-(3-oxopropyl)benzaldehyde | 90392-95-3 |
| 4-but-3-enylbenzaldehyde | 137658-83-4 |
| [4-(cyclopropanecarbonyl)phenyl] formate | |
| 4-heptoxybenzaldehyde | 27893-41-0 |
| 4-pentoxyphenol | 18979-53-8 |
| 4-butylbenzaldehyde | 1200-14-2 |
| 4-carboxy-2-methoxycarbonylphenolate | |
| 4-hydroxy-3-methoxycarbonylbenzoic acid | 41684-11-1 |
| 4-(2-methylpropyl)benzaldehyde | 40150-98-9 |
| 4-propylbenzaldehyde | 28785-06-0 |
| 5,5-dimethyl-3-propylcyclohex-2-en-1-ol | 118465-28-4 |
| 5-ethylbenzene-1,3-dicarbaldehyde | 118792-76-0 |
| 5-methoxynaphthalen-2-ol | 150712-57-5 |
| 9-methoxyanthracene | 2395-96-2 |
| prop-2-enylbenzene | 128961-80-8, |
| | 57807-91-7, |
| | 25988-53-8, |
| | 300-57-2 |
| butyl 2-oxocyclohexane-1-carboxylate | 64486-45-9 |
| butyl 2-oxocyclopentane-1-carboxylate | 6627-69-6 |
| cyclopropyl-(4-ethoxyphenyl)methanone | 75343-44-1 |
| cyclopropyl-(4-propan-2-yloxyphenyl)methanone | 1152833-63-0 |
| cyclopropyl-(4-methoxyphenyl)methanone | 7152-03-6 |
| cyclopropyl-(4-propoxyphenyl)methanone | 1226182-72-4 |
| decyl 2-oxocyclohexane-1-carboxylate | |
| diethyl 2-(4-ethylphenyl)propanedioate | 29148-28-5 |
| diethyl 2-(4-methylphenyl)propanedioate | 29148-27-4 |
| diethyl 2-phenylpropanedioate | 83-13-6 |
| dimethyl 4-hydroxybenzene-1,3-dicarboxylate | 5985-24-0 |
| ethyl 2-oxocyclohexane-1-carboxylate | 1655-07-8, |
| | 4840-68-0 |
| ethyl 2-oxocyclopentane-1-carboxylate | 611-10-9 |
| ethyl 3,4-dimethoxybenzoate | 3943-77-9 |
| ethynylbenzene | 536-74-3, |
| | 120851-94-7, |
| | 25038-69-1 |
| hexyl 2-oxocyclohexane-1-carboxylate | 1631736-32-7 |
| hexyl 2-oxocyclopentane-1-carboxylate | 72845-82-0 |
| methyl 2,5-dioxocyclopentane-1-carboxylate | 2825007-84-7 |
| methyl 2-hydroxy-5-(hydroxymethyl)benzoate | 183430-63-9 |
| methyl 2-hydroxy-5-(methoxymethyl)benzoate | 861315-31-3 |
| methyl 2-oxocyclopentane-1-carboxylate | 10472-24-9 |
| methyl 3,4-dimethoxybenzoate | 2150-38-1, |
| | 3943-74-6 |
| methyl 4-hydroxy-3-methoxybenzoate | 3943-74-6 |
| methyl 5-(hydroxymethyl)pyrazine-2-carboxylate | 1262803-64-4 |
| methyl 5-(methoxymethyl)pyrazine-2-carboxylate | 1388149-35-6 |
| methyl 5-formylpyrazine-2-carboxylate | 710322-57-9 |
| methyl 5-methylpyrazine-2-carboxylate | 41110-33-2 |
| methyl 2-oxocyclopentane-1-carboxylate | 10472-24-9 |
| methyl pyrazine-2-carboxylate | 6164-79-0 |
| propyl 2-oxocyclohexane-1-carboxylate | 29537-13-1 |
| tert-butyl 4-(2-aminoethyl)-4-methylpiperidine-1- | 946517-83-5 |
| carboxylate | |
| tert-butyl 4,4-diethylpiperidine-1-carboxylate | 1498576-45-6 |
| tert-butyl 4,4-dimethylpiperidine-1-carboxylate | 1252572-05-6 |
| tert-butyl 4-ethyl-4-methylpiperidine-1-carboxylate | 1495020-67-1 |
| tert-butyl 6-azaspiro[2.5]octane-6-carboxylate | 955028-67-8 |
| ethenyl 3,4-dimethoxybenzoate | 1644148-22-0 |

### Process of Making a Consumer Product

The present disclosure also relates to processes of making a consumer product. For example, the process may comprise the steps of: combining a first fragrance material with a treatment adjunct or a substrate, where the first fragrance material is a meta-(C1-C4 alkoxy)salicylaldehyde, preferably meta-(C1-C2 alkoxy)salicylaldehyde, more preferably meta-(C2 alkoxy)salicylaldehyde.

Preferably, the first fragrance material is in liquid form. The first fragrance material may be combined with one or more other materials. For example, the first fragrance material may be part of a fragrance or flavoring composition that comprises at least a second fragrance material.

In the processes of the present disclosure, the process may comprise flowing the first fragrance material through a pipe. The first fragrance material may be flowed through the pipe at a temperature above the melting point of the first fragrance material. For example, the process may comprise flowing the first fragrance material through a pipe at a temperature at or above 44.5° C., e.g., when the first fragrance material comprises ortho-vanillin. The process may comprise flowing the first fragrance material through a pipe at a temperature at or above 64° C., e.g., when the first fragrance material comprises ortho-ethylvanillin. The process may comprise flowing the first fragrance material through a pipe at a temperature of from about 44.5° C. to about 80° C., preferably from about 44.5° C. to about 77.5° C., more preferably from about 64° C. to about 77.5° C.

In an effort to conserve energy and heating costs, it may be desirable to flow the first fragrance material through a pipe at a relatively low temperature. For example, it maybe preferred that the first fragrance material is flowed through a pipe at a temperature that is less than 80° C., more preferably less than 77.5° C.

For similar reasons, it may be desirable to flow the first fragrance material through the pipe at a temperature that is at a lower temperature than the melting point of the first fragrance material's isomeric counterpart that has the hydroxyl group at a para-position, thereby taking advantage of the properties of the presently described materials. For example, the process may comprise flowing the first fragrance material through a pipe at a temperature at or below 80° C., e.g., when the first fragrance material comprises ortho-vanillin. For example, the process may comprise flowing the first fragrance material through a pipe at a temperature at or below 77.5° C., e.g., when the first fragrance material comprises ortho-ethylvanillin.

The first fragrance material may be part of a fragrance or flavoring composition, which may be combined with a treatment adjunct to form a consumer product.

The treatment adjunct may be part of a base composition, which may comprise two or more treatment adjuncts. Suitable treatment adjuncts are described above. The base composition may be a liquid composition, which may also be flowable through a pipe.

The consumer products of the present disclosure can be formulated into any suitable form and prepared by any process chosen by the formulator. The first fragrance materials, second fragrance materials (if any), fragrance or flavoring compositions, treatment adjuncts, and/or base compositions may be combined in a batch process, in a circulation loop process, and/or by an in-line mixing process. Suitable equipment for use in the processes disclosed herein may include continuous stirred tank reactors, homogenizers, turbine agitators, recirculating pumps, paddle mixers, high shear mixers, static mixers, plough shear mixers, ribbon blenders, vertical axis granulators and drum mixers, both in batch and, where available, in continuous process configurations, spray dryers, and extruders.

The resulting compositions may be placed into a container to form a consumer product, as described herein. The container may be a bottle, preferably a plastic bottle. The resulting composition may be placed into an aerosol or other spray container according to known methods.

The process may comprise the steps of combining a first fragrance material with a substrate. The substrate may be a non-woven sheet. The substrate may be an absorbent material or article. The first fragrance may be combined with the substrate by any suitable method, including spraying.

Process of Treatment

The present disclosure also relates to a process of treating a surface or an environment with a meta-(C1-C4 alkoxy)salicylaldehyde, preferably a meta-(C1-C2 alkoxy)salicylaldehyde, more preferably a meta-(C2 alkoxy)salicylaldehyde, as described in more detail above. The meta-(C1-C4 alkoxy)salicylaldehyde may be part of a consumer product.

The process of treatment comprises the step of providing the meta-(C1-C4 alkoxy)salicylaldehyde to a surface or environment. Suitable surfaces may include fabric, hard surfaces, dishware, hair, or skin. Suitable environments may include interior spaces such as a room in a residential dwelling, a commercial property, or an industrial setting.

The process may include the step of contacting a surface, preferably a fabric, with the meta-(C1-C4 alkoxy)salicylaldehyde, optionally as part of a consumer product according to the present disclosure.

The process may include the step of providing the meta-(C1-C4 alkoxy)salicylaldehyde to an environment, preferably an interior environment, optionally as part of a consumer product according to the present disclosure. The step of providing the meta-(C1-C4 alkoxy)salicylaldehyde may occur via a spraying process or through diffusion.

### Use

The present disclosure also relates to the use of a meta-(C1-C4 alkoxy)salicylaldehyde, preferably a meta-(C1-C2 alkoxy)salicylaldehyde, more preferably a meta-(C2 alkoxy)salicylaldehyde, to provide a vanilla-type fragrance to a consumer product, a surface, or an environment. Such materials, products, surfaces, and environments are discussed in more detail above.

### COMBINATIONS

Specifically contemplated combinations of the disclosure are herein described in the following lettered paragraphs. These combinations are intended to be illustrative in nature and are not intended to be limiting.

A. A consumer product comprising: a first fragrance material that is a meta-(C1-C4 alkoxy)salicylaldehyde, wherein the first fragrance material is present in an amount of at least 0.0005%, by weight of the consumer product composition, and a treatment adjunct.

B. A consumer product comprising: a first fragrance material that is a meta-(C1-C4 alkoxy)salicylaldehyde, an optional second fragrance material selected from the group consisting of vanillin, ethylvanillin, or a combination thereof, wherein the weight ratio of the first fragrance material to the second fragrance material, if present, is from 100:0 to 1:99; and a treatment adjunct.

C. The consumer product according to any of paragraphs A or B, wherein the first fragrance material is a meta-(C1-C2 alkoxy)salicylaldehyde.

D. The consumer product according to any of paragraphs A-C, wherein the first fragrance material is a meta-(C2 alkoxy)salicylaldehyde.

E. The consumer product according to any of paragraphs A-D, wherein the alkoxy group in the first fragrance material is a linear alkoxy group.

F. The consumer product according to any of paragraphs A-E, wherein the first fragrance material is present in the consumer product in an amount of at least 0.001%, preferably at least 0.01%, more preferably at least 0.1%, more preferably at least 0.5%, more preferably at least 1%, by weight of the consumer product.

G. The consumer product according to any of paragraphs A-F, wherein the first fragrance material is synthetically prepared.

H. The consumer product according to any of paragraphs A-G, wherein the first fragrance material is part of a perfume delivery system, where the perfume delivery system is a delivery particle, a pro-fragrance material, or a combination thereof.

I. The consumer product according to any of paragraphs A-H, wherein the weight ratio of the first fragrance material to the second fragrance material, if present, is from 100:0 to 25:75, preferably from 100:0 to 50:50, more preferably from 100:0 to 51:49, more preferably from 100:0 to 75:25, more preferably from 100:0 to 90:10, more preferably from 100:0 to 95:5, more preferably from 100:0 to 99:1.

J. The consumer product according to any of paragraphs A-I, wherein the consumer product is substantially free of a second fragrance material selected from the group of vanillin, ethylvanillin, and a combination thereof.

K. The consumer product according to any of paragraphs A-J, wherein the treatment adjunct is selected from surfactants, conditioning actives, deposition aids, rheology modifiers or structurants, bleach systems, stabilizers, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, silicones, hueing agents, aesthetic dyes, neat perfume, additional perfume delivery systems, structure elasticizing agents, carriers, hydrotropes, processing aids, anti-agglomeration agents, coatings, formaldehyde scavengers, pigments, or mixtures thereof.

L. The consumer product according to any of paragraphs A-K, wherein the treatment adjunct comprises a carrier, preferably a carrier comprising isopropyl myristate (IPM), dipropylene glycol, propylene glycol monomethyl ether (DPM), tripropyleneglycol monomethyl ester (TPM), or triethyl citrate (TEC), more preferably a carrier comprising isopropyl myristate.

M. The consumer product according to any of paragraphs A-L, wherein the consumer product is a baby care product, a beauty care product, a fabric care product, a home care product, a family care product, a feminine care product, a health care product, a food product, a beverage product, a fine fragrance product, or a combination thereof.

N. The consumer product according to any of paragraphs A-M, wherein the consumer product is a fabric care product and/or a home care product, wherein the home care product is selected from the group consisting of a hard surface cleaner, a dish care product, an air care product, or a combination thereof.

O. The consumer product according to any of paragraphs A-N, wherein the consumer product comprises a form selected from a liquid composition, a granular composition, a hydrocolloid, a single-compartment pouch, a multi-compartment pouch, a dissolvable sheet, a pastille or bead, a fibrous article, a tablet, a stick, a bar, a flake, a spray, a foam/mousse, a non-woven sheet, a cream, an absorbent article, a paste, an adhesive, an adhesive patch, or a mixture thereof.

P. A fragrance or flavoring composition comprising: a first fragrance material that is a meta-(C1-C4 alkoxy)salicylaldehyde, preferably meta-(C1-C2 alkoxy)salicylaldehyde, more preferably meta-(C2 alkoxy)salicylaldehyde, wherein the first fragrance material is present in an amount of at least 0.005%, by weight of the fragrance or flavoring composition, and a second fragrance material that is different from the first fragrance material.

Q. The fragrance or flavoring composition according to paragraph P, wherein the fragrance or flavoring composition further comprises a carrier, preferably a carrier comprising isopropyl myristate (IPM), dipropylene glycol, propylene glycol monomethyl ether (DPM), tripropyleneglycol monomethyl ester (TPM), triethyl citrate (TEC), or a mixture thereof, more preferably a carrier comprising isopropyl myristate.

R. A consumer product comprising the fragrance or flavoring composition according to any of paragraphs P or Q, preferably wherein the consumer product is a baby care product, a beauty care product, a fabric care product, a home care product, a family care product, a feminine care product, a health care product, a food product, a beverage product, a fine fragrance product, or a combination thereof.

S. The consumer product according to paragraph R, wherein the fragrance or flavoring composition is present in the consumer product in an amount of at least 0.1%, preferably at least 0.5%, more preferably at least 1%, by weight of the consumer product.

T. A process of making a consumer product, the process comprising the steps of: combining a first fragrance material with a treatment adjunct or a substrate, wherein the first fragrance material is a meta-(C1-C4 alkoxy)salicylaldehyde, preferably meta-(C1-C2 alkoxy)salicylaldehyde, more preferably meta-(C2 alkoxy)salicylaldehyde.

U. The process according to paragraph T, wherein the first fragrance material is in liquid form.

V. The process according to any of paragraphs T or U, wherein the first fragrance material is flowed through a pipe, preferably at a temperature that is less than 80° C., more preferably less than 77.5° C.

W. A process of treating a surface or an environment, the process comprising the step of providing a meta-(C1-C4 alkoxy)salicylaldehyde, preferably a meta-(C1-C2 alkoxy)salicylaldehyde, more preferably a meta-(C2 alkoxy)salicylaldehyde, to a surface or environment.

X. A use of a meta-(C1-C4 alkoxy)salicylaldehyde, preferably a meta-(C1-C2 alkoxy)salicylaldehyde, more preferably a meta-(C2 alkoxy)salicylaldehyde, to provide a vanilla-type fragrance to a consumer product, a surface, or an environment.

### TEST METHODS

It is understood that the test methods disclosed in the Test Methods section of the present application should be used to determine the respective values of the parameters of Applicant's claimed subject matter as claimed and described herein.

### Solubility Method

Solutions of vanillin (121-33-5), ethylvanillin (121-32-4), and o-ethylvanillin (492-88-6) are prepared at 8.00E⁻² g/L in IPM. Each of these is used to make five additional sequential serial two-fold dilutions with IPM giving a set of six solutions for each solute. The absorbance values for solutions of vanillin and ethyl vanillin (at 300 nm), and of o-ethylvanillin (at 343 nm) are used to create standard calibration curves for each molecule (linear regression correlation coefficients R²>0.998).

Mixtures of each compound at 1, 5, 10, 15, 20, 25, and 30 weight percent in IPM are prepared by adding the solid compound to IPM, sonicating at 50° C. for 1 hour and allowing to cool to room temperature for 3 hours. Some of these solutions are saturated, i.e. are comprised of both dissolved and undissolved compound. Saturated solutions of each compound are then filtered to remove undissolved compound and each filtrate was diluted 1:10,000 in IPM. The absorbance values of the filtrates of vanillin and of ethyl vanillin (at 300 nm), and of o-ethylvanillin (at 343 nm) are used to calculate the concentration based on the calibration curves, and the maximum concentration values are considered to be the solubility limits for vanillin, ethyl vanillin, and o-ethylvanillin in IPM.

### Headspace Method

Perfume headspace data is collected for various materials according to the method provided below.

The partition coefficients are calculated by determining the amount of PRM in the headspace above a solution with a known concentration using a GC/FID-MS (Agilent 7890 and 5977A MSD) with a thermal desorption unit (Gerstel MPS2) and Dynamic Headspace Sampler (Gerstel DHS). This technique allows for automated headspace collections using the MultiPurposeSampler (MPS). The PRMs of interest are prepared at a known concentration in isopropyl myristate (IPM) or propylene glycol monomethyl ether (DPM), and 1 mL is pipetted in a 20 mL headspace vial.

DHS Conditions: The sample is tempered in the unit at 30° C. A helium stream at 10 mls/min purges 20 mL of headspace containing the analytes above the sample onto the sorbent tube (TDU) containing 25 mg of TenaxTA 35/60 (Restek cat #25701).

TDU conditions: The sorbent tube is desorbed with a program starting at 30° C. solvent vent for 2 min then ramped at 720° C./min to 270° C. and held for 8 min. The analytes are refocused on a glass bead liner at −60° C. then desorbed at a rate of 12° C./s to 270° C. onto the GC column.

GC/MS conditions: Agilent 122-5532UI column of 30 m×250 μm×0.25 μm and a flow rate of 1.5mL/min is utilized. A temperature program of 50° C. to 280° C. with a 2 min hold and a ramp rate of 12° C./min is suitable. Scan or SIM mode MSD parameters with a solvent delay for the DPM are applied to achieve appropriate detection.

Analytical standards can be obtained from Sigma Aldrich, St. Louis, MO and BioSynth, UK. A stock solution is prepared at approximately 0.5 g/L. The stock solution is then diluted to 4 to 5 concentrations ranging from approximately 0.05 g/L to 0.00005 g/L. These standard solutions are then analyzed by GC/MS. This analysis is performed by using the same TDU desorption and GC/MS conditions described above with a 1 uL liquid injection onto the TDU tube instead of the DHS collection. The amount injected on column and the area responses of the target m/z are utilized to create a calibration plot with a linear fit.

Quantification of the headspace is performed by the PRM target m/z area response of the perfume component and the linear equation of the calibration plot.

### EXAMPLES

The examples provided below are intended to be illustrative in nature and are not intended to be limiting.

### Example 1. Comparison of Materials and Characteristics/Physical Properties

The following tables compare the structures and various characteristics of materials according to the present disclosure with their isomeric counterparts. Specifically, Table 1 compares comparative material vanillin to ortho-vanillin (aka, meta-(C1 alkoxy)salicylaldehyde). Table 2 compares comparative material ethylvanillin to ortho-ethylvanillin (aka, meta-(C2 alkoxy)salicylaldehyde).

TABLE 1

| | | ortho-Vanillin |
|---|---|---|
| | Vanillin | (aka, meta-(C1 |
| | (comp.) | alkoxy)salicylaldehyde) |
| Structure | 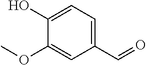 | 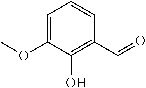 |
| CAS No. | 121-33-5 | 148-53-8 |
| Melting Point | 80-81° C. | 44.5° C. |
| Boiling Point | 284-285° C. | 265.5° C. |
| ClogP | 1.208 ± 0.272 | 1.600 ± 0.279 |

TABLE 2

| | | ortho-Ethylvanillin |
|---|---|---|
| | Ethylvanillin | (aka, meta-(C2 |
| | (comp.) | alkoxy)salicylaldehyde) |
| Structure | 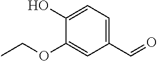 | 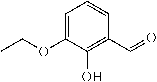 |
| CAS No. | 121-32-4 | 492-88-6 |
| Melting Point | 77.5° C. | 64-65° C. |
| Boiling Point | 285° C. | 263-264° C. |
| ClogP | 1.718 ± 0.272 | 2.109 ± 0.279 |
| Solubility | 0.038 | 0.073 |
| (g/mL) in | | |
| IPM | | |

As shown in Tables 1 and 2, compared to its isomer (vanillin and ethylvanillin, respectively, having the hydroxyl in the para-position), the ortho-version of each material is characterized by a lower melting point, which is associated with a decreased tendency to crystallize and which indicates that lower amounts of energy are required to melt and flow the material through a pipe.

Furthermore, the ortho-version of each material is characterized by a lower boiling point, which tends to be associated with a higher vapor pressure. Such materials are likely to volatilize more easily and may therefore be perceived at lower levels in a consumer product. This in turn allows them to be formulated at lower levels, thereby saving formulation space.

Additionally, the ortho-version of each material is characterized by a higher ClogP than its para-counterpart, indicating that the ortho-materials are relatively more hydrophobic and/or may partition into hydrophobic solvents (such as IPM) more efficiently. With regard to ethylvanillin vs. ortho-ethylvanillin, this is shown by the differences in solubility in IPM.

### Example 2. Headspace Data

Perfume headspace data is collected for various materials according to the Headspace Method provided above in the Test Methods section. The Air/Solvent partition coefficients are determined and indexed accordingly (e.g., where the partition coefficient for ethylvanillin is set at 1.00).

Results for vanillin, ethylvanillin, and ortho-ethylvanillin in isopropyl myristate (IPM) and propylene glycol monomethyl ether (DPM) are provided below in Table 3 and 4, respectively.

TABLE 3

| | | | | Air/IPM | |
|---|---|---|---|---|---|
| | | Concen- | Head- | partition coef | Ethylvanillin |
| | | tration | space | (ng/mL in air | Indexed Air/ |
| | CAS | in IPM | (ng/ | per ng/mL in | IPM partition |
| Sample | No. | (ng/mL) | mL)* | IPM)* | coefficient* |
| Vanillin | 121- | 2.07E+06 | 0.0563 | 2.73E−08 | 1.40 |
| (comp.) | 33-5 | | | | |
| Ethylvanillin | 121- | 2.06E+06 | 0.0402 | 1.95E−08 | 1.00 |
| (comp.) | 32-4 | | | | |
| ortho- | 492- | 2.10E+06 | 0.2521 | 1.21E−07 | 6.17 |
| Ethylvanillin | 88-6 | | | | |

*average of two replicates.

TABLE 4

| | | | | Air/DPM | |
|---|---|---|---|---|---|
| | | Concen- | Head- | partition coef | Ethylvanillin |
| | | tration | space | (ng/mL in air | Indexed Air/ |
| | CAS | in DPM* | (ng/ | per ng/mL in | DPM partition |
| Sample | No. | (ng/mL) | mL)* | DPM)* | coefficient* |
| Vanillin | 121- | 1.1E+07 | 0.1288 | 1.21E−08 | 4.88 |
| (comp.) | 33-5 | | | | |
| Ethylvanillin | 121- | 1.1E+07 | 0.0262 | 2.45E−09 | 1.00 |
| (comp.) | 32-4 | | | | |
| ortho- | 492- | 1.1E+07 | 2.4678 | 2.31E−07 | 93.7 |
| Ethylvanillin | 88-6 | | | | |

*average of three replicates.

Overall, ortho-ethylvanillin goes into the headspace about 6.2× more than its structural isomer ethylvanillin out of IPM, a common solvent used in perfume delivery particles, and about 94× more than ethylvanillin out of DPM. The increase in volatility of ortho-ethylvanillin compared to ethylvanillin is advantageous because a higher fraction of ortho-ethylvanillin will be found in the air than the consumer product. Therefore, ortho-ethylvanillin will be more likely to be perceived at lower levels in consumer products or at greater intensity at equal levels in consumer products.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product comprising:
a first fragrance material that is a meta-(C1-C4 alkoxy)salicylaldehyde, wherein the first fragrance material is present in an amount of at least 0.0005%, by weight of the consumer product composition, and
a treatment adjunct.

2. The consumer product according to claim 1, wherein the first fragrance material is a meta-(C1-C2 alkoxy)salicylaldehyde.

3. The consumer product according to claim 1, wherein the first fragrance material is a meta-(C2 alkoxy)salicylaldehyde.

4. The consumer product according to claim 1, wherein the alkoxy group in the first fragrance material is a linear alkoxy group.

5. The consumer product according to claim 1, wherein the first fragrance material is present in the consumer product in an amount of at least 0.001%, by weight of the consumer product.

6. The consumer product according claim 1, wherein the first fragrance material is synthetically prepared.

7. The consumer product according to claim 1, wherein the first fragrance material is part of a perfume delivery system, where the perfume delivery system is a delivery particle, a pro-fragrance material, or a combination thereof.

8. A consumer product comprising:
a first fragrance material that is a meta-(C1-C4 alkoxy)salicylaldehyde,
a second fragrance material selected from the group consisting of vanillin, ethylvanillin, or a combination thereof,
wherein the weight ratio of the first fragrance material to the second fragrance material is from 100:0 to 1:99; and
a treatment adjunct.

9. The consumer product according to claim 8, wherein the first fragrance material is a meta-(C1-C2 alkoxy)salicylaldehyde.

10. The consumer product according to claim 8, wherein the first fragrance material is a meta-(C2 alkoxy)salicylaldehyde.

11. The consumer product according to claim 8, wherein the alkoxy group in the first fragrance material is a linear alkoxy group.

12. The consumer product according to claim 8, wherein the first fragrance material is present in the consumer product in an amount of at least 0.001% by weight of the consumer product.

13. The consumer product according to claim 8, wherein the first fragrance material is synthetically prepared.

14. The consumer product according to claim 8, wherein the first fragrance material is part of a perfume delivery system, where the perfume delivery system is a delivery particle, a pro-fragrance material, or a combination thereof.

15. The consumer product according to claim 8, wherein the weight ratio of the first fragrance material to the second fragrance material, is from 100:0 to 25:75.

16. The consumer product according to claim 8, wherein the treatment adjunct is selected from surfactants, conditioning actives, deposition aids, rheology modifiers or structurants, bleach systems, stabilizers, builders, chelating agents, dye transfer inhibiting agents, dispersants, enzymes, enzyme stabilizers, catalytic metal complexes, polymeric dispersing agents, clay and soil removal/anti-redeposition agents, brighteners, suds suppressors, silicones, hueing agents, aesthetic dyes, neat perfume, additional perfume delivery systems, structure elasticizing agents, carriers, hydrotropes, processing aids, anti-agglomeration agents, coatings, formaldehyde scavengers, pigments, or mixtures thereof.

17. The consumer product according to claim 8, wherein the treatment adjunct comprises a carrier,
a carrier comprising isopropyl myristate (IPM), dipropylene glycol, propylene glycol monomethyl ether (DPM), tripropyleneglycol monomethyl ester (TPM), triethyl citrate (TEC), or a mixture thereof.

18. The consumer product according to claim 8, wherein the consumer product is a baby care product, a beauty care product, a fabric care product, a home care product, a family care product, a feminine care product, a health care product, a food product, a beverage product, a fine fragrance product, or a combination thereof.

19. The consumer product according to claim 8, wherein the consumer product is a fabric care product and/or a home care product,
wherein the home care product is selected from the group consisting of a hard surface cleaner, a dish care product, an air care product, or a combination thereof.

20. A process of treating a surface or an environment,
the process comprising the step of providing meta-(C2 alkoxy)salicylaldehyde to a surface or environment.
